(19) United States
(12) Patent Application Publication
(10) Pub. No.: US 2016/0072681 A1
(43) Pub. Date: Mar. 10, 2016

(54) SYSTEM AND METHOD FOR CRITERIA-BASED OPTIMIZED TRANSFER OF PHYSICAL OBJECTS OR PEOPLE BETWEEN DIFFERENT GEOGRAPHIC LOCATIONS INCLUDING AN EXEMPLARY EMBODIMENT FOR PATIENTS TRANSFER BETWEEN HEALTH CARE FACILITIES

(71) Applicant: OpenBeds Inc., Washington, DC (US)

(72) Inventors: Nishi Rawat, Washington, DC (US); Surendra Rawat, Ottawa (CA)

(21) Appl. No.: 14/846,715

(22) Filed: Sep. 4, 2015

Related U.S. Application Data
(60) Provisional application No. 62/046,095, filed on Sep. 4, 2014.

(51) Int. Cl. H04L 12/24; H04L 12/26; G06F 3/0484

(52) U.S. Cl. CPC H04L 41/22; G06F 3/04842; G06F 3/04847; H04L 43/0876; H04L 43/04; H04L 41/5054

(57) ABSTRACT

This invention comprises a stream-lined Transfer System with automated Processes for the purpose of user input attributes or criteria driven optimized and efficient transfer of physical objects or people between geographic locations. The system facilitates in an innovative and unique way resource identification, allocation and transfers by supporting real-time transactions between senders and receivers, using real-time secured electronic communication and electronic exchange of documents. An exemplary embodiment of the system and process is transfer of patients between health care service providers' facilities; a system called OpenBeds® is one such embodiment.

### PRIORITY CLAIM

The present application claims priority to U.S. Provisional Patent Application Ser. No. 62/046,095, filed Sep. 4, 2014, entitled “A system for criteria-based transfer of tangible physical objects or people between different geographic locations via secured real-time electronic communication and automated processes, including an exemplary embodiment for patient transfer between health care facilities,” which is incorporated herein by reference in its entirety.

### BACKGROUND

1. Field of Invention

The present invention relates to a system, and associated optimal and efficient processes and methods and system's components capabilities for automated optimized transfer of people, tangible products, objects and/or materials, between different geographical locations, with associated electronic communication and documentation of activities and communications required for such transfers. This disclosure also relates to a specific preferred embodiment of such a system for optimal and efficient transfer of patients between units within a Health Services Provider's (HSP) physical health care facilities, such as, but not limited to, hospitals, psychiatric facilities, rehabilitation facilities, and nursing homes and patient transfer referrals with support for specific specialized medical conditions.

2. Description of the Related Art

The transfer of people and objects to different geographic locations, based on availability of facilities and allocation of resources, is challenged by poor and untimely communication, using dated methodologies and tools, resulting in inefficiency and high cost.

As a specific example, patients are transferred from a community to a tertiary hospital (specialized and academic institution) when needs exceed resources available at the community facility. The inter-hospital transfer of critically ill patients is associated with excessive morbidity, mortality, and expense, due to informational deficiencies. The current process by which critically ill patients are transferred from community to tertiary care hospitals is complex, potentially unsafe and expensive. Community providers routinely make several phone calls to multiple tertiary care hospitals to check on bed and provider availability. Tertiary bed and provider availability are in demand and ever-changing, resulting in community providers repeatedly telephone institutions to determine patient acceptance. Tertiary bed triage and allocation is multidimensional and opaque to community providers, adding complexity, risk and cost. Logistics of bed and provider finding are labour-intensive, while ongoing care of patients is compromised and transfers are delayed, contributing to worsened outcomes. Written transfer summaries are hurried, handled manually, and inter-provider handoffs inadequate, resulting in misguided care and redundant diagnostics at the tertiary institution. Thus, transferred patients suffer from worsened outcomes, and incur greater costs, despite controlling for severity of illness.

Thus, typical ‘as-is’ processes entail different physical location coordinators to talk with each other over the phone, and when required, supplement by unsecured electronic mail and/or fax to exchange documents, to facilitate transfers. A typical system in existence may contain rudimentary automation with partial use of electronic support systems to facilitate transfers.

### Some Sample Embodiments

An objective of this invention is to address shortcomings described above, along with others that are apparent in this disclosure and that are known to persons of skill in the art.

According to embodiments, the Transfer System comprises a unique secured web based unique interactive access using computer-centric fixed or mobile wireless electronic devices, secured transmission of information across public or private wired or wireless telecommunications networks, and a unique secured database management system deployed on secured servers located at enterprise's own premises or a remote location. Inputs to the database regarding system configuration and user information are placed by the system administrator using graphic interfaces.

According to embodiments, the Transfer Process and supporting software comprises user interaction with the Transfer System using unique interactive graphic screens displayed on the web browser of the electronic access device. The user inputs qualifying criteria to locate optimal facilities for transfer of objects or people. The server includes appropriate back-end interfaces and algorithms embedded in the software to analyse and manipulate data for interactive use and display on the browser of the electronic access device such that the user can carry out the optimal transfer. All sending and receiving users' transactions and deliberations are carried out through the web-based screens of the Transfer System, and are recorded with corresponding time-stamps.

In an embodiment, system usage related statistics and analytics are generated, recorded, and displayed in appropriate format for the purpose of system's performance evaluation and assessment of utilization of system capacity. Data can be retrieved, printed or converted into appropriate usable forms and media.

An exemplary and preferred embodiment of the system and processes in the disclosure presented here is OpenBeds®, which is a patient transfer system for health care enterprises consisting of several Institutions (such as, hospitals) and Units (facilities) situated at different geographic locations, where Units are equipped with respective qualifying capabilities or attributes, and patient transfer entails optimal selection of a specific Unit for patient transfer, based on user-defined attributes and criteria. Examples of such units are: Intensive Care Units and Emergency Departments, nursing homes, psychiatric facilities, and substance abuse rehabilitation centers, etc.

In embodiments, the Transfer System, and processes and methods described herein, automate the transfer process using secure and confidential web-based communication, storage and manipulation of data using optimizing algorithms. Transfers are optimized using user-defined attributes of locations and objects or people, and system-based algorithms. Data are accessed from computer-centric servers using unique interactive screens displaying real time data and notifications to users of actions taken and messages exchanged. Data may be accessed on any browser via any type of computer-centric wired or wireless electronic communication device. The present invention generally relates to real-time interactions between the sending site coordinating person and the receiving site coordinating person for the purpose of transfer of tangible objects or persons with the assistance of information and communication technologies (ICT) across public or private communication networks in a secured manner.

In embodiments, the sending and receiving users use controlled, secured and authenticated, access to the computer-centric secured server containing relevant data and information.

In embodiments, the users can access and interact with the system using, but not limited to, fixed computer-centric electronic device, such as personal computers or workstations, or hand-held or wearable mobile or fixed computer-centric electronic device, such as, a mobile phone, a wearable smart watch or goggles, or a near field communications device. In embodiments, the access devices have unique device compatible screen graphics interfaces for the user.

In embodiments, the server constitutes a secured database of relevant data. It also has optimizing algorithms to analyse and manipulate data for the purpose of real-time optimal decision making for transfers. The server could be located on user's premises or elsewhere in the cloud.

In embodiments, the communication between the sender and the receiver of assets or people being transferred is done in a secured manner with encryption of all messages, but not limited to, in order to comply with application specific security requirements.

In embodiments, the data stored in the server are encrypted, but not limited to, in order to comply with application specific security requirements.

In embodiments, the optimizing algorithms used on the server for optimal selection and allocation of resources based on user defined attributes include, but are not limited to, order ranking based on criticality (priority) of transfer, time required to transfer, distance between geographic locations, cost involved in transfer, and any policy variables; such optimizing algorithms are based on linear and nonlinear mathematical programming techniques minimizing (or maximizing) a metric value which is a function of one or more of these variables.

In embodiments, statistics and analytics for system performance assessment are generated automatically by the database of the system. Data are analyzed and reports are generated in physical (paper-based) or electronic media formats. Users may access these by inputting queries on visual displays on the user's electronic access device.

Additionally, in yet further embodiments, the entire system with its novel embodiments summarized in the above, but not limited to, has hooks (connectivity) electronically for integrating into other existing systems of the user's enterprise. Such hooks typically, but not limiting, are required for the purpose of retrieving and transmitting relevant data, or communicating with other individuals, residing in other systems of the user's enterprise. Additionally, such user's enterprise data are used to predict availability of resources in the user's enterprise using predictive analytics algorithms, which then automatically populates the availability related information in the System and is input into the System's algorithms to facilitate transfers.

In totality, the above embodiments, along with others that are apparent in this disclosure, are included in an embodiment included herewith for the purpose of transfer of patients between health care facilities, such as, but not limited to, hospitals, psychiatric facilities and nursing homes, with support for specific specialized medical conditions. No such system exists at present which addresses a comprehensive set of requirements, including automating time-sensitive communications, reducing human intervention and associated delays, and facilitating the implementation of transfer-related optimal and efficient processes. This system will improve the current patient transfer process which is largely manual by:
Making facilities availability transparent
   Saves provider time for value-add activities such as providing patient care
   Improves facility reputation by improving service
Improving system capacity: volume of transfers (e.g., patients) and throughput
   Increased transparency increases volumes
   Analytics to track bed demand and use
Improving inter-Institution (e.g., medical facilities providers) communication
   Electronic messaging for entire transfer logistics (e.g., for patient transfers)
   Messaging records for audits and transparency

For various example embodiments, in which the application is that of a patient transfer between different institutions, for the first time a physician or hospital administrator or health services provider may be using the embodiments of the current invention in a very cost-effective way and save lives by timely transfers of patients, with a very significant departure from currently used manual systems with very limited electronic transactions. Additionally, the system, with its open interfaces, will provide hooks into other existing and new systems, such as, electronic health record systems for automated input of relevant data and information.

The system, methods/processes, software, objects, features, and advantages of the present invention with embodiments listed in the above summary of the invention, but not limited to, will be apparent to those skilled in the art from the following detailed description of the preferred embodiment and drawings.

### BRIEF DESCRIPTION OF THE DRAWINGS

FIG. 1 is a schematic architectural diagram of the transfer system for transferring tangible physical objects or people between different locations, according to exemplary embodiments;

FIGS. 2A and 2B depict a graphical user interface for user log-in into and registration with the HSP System, according to embodiments;

FIG. 3 depicts real-time availability of Units (facilities) in a Health Services Provider (HSP) enterprise consisting of multitude of Institutions (hospitals), with respective serving units, according to various embodiments;

FIG. 4 depicts a graphical user interface for real-time updating availability of Units in the HSP, according to exemplary embodiments;

FIGS. 5A-C depict a patient transfer request interface, according to various embodiments;

FIG. 6 depicts a patient transfer request status interface, according to embodiments;

FIG. 7 depicts an interface for real time actions taken at a Unit and messaging between Transfer Coordinators of sending and receiving Units for patient transfers, according to embodiments;

FIG. 8 depicts a dashboard of Analytics associated with the activities of the HSP, according to exemplary embodiments;

FIGS. 9A-C depicts an illustration of a server-based database of an HSP System, according to exemplary embodiments;

FIG. 10 depicts a flow chart of a process for a user, including logging in, sending a transfer request, completing transfer, according to one embodiment;

FIG. 11 depicts an interactive graphical user interface used by a Unit Administrator for updating Unit's users' availability at any point in time, according to embodiments;

FIG. 12 depicts a flow chart of a process of taking action by an Administrator, according to one embodiment;

FIG. 13 depicts a flow chart of a process of taking action by a System Administrator, according to one embodiment;

FIG. 14 depicts a repository for patient transfers in a patient exchange manifestation of the system, according to exemplary embodiments;

FIG. 15 is an exemplary diagram of a mobile device (e.g., handset) that can be used to implement an embodiment of the invention;

FIG. 16 is an exemplary diagram of hardware and interfaces with communications network that can be used to implement an embodiment of the invention; and

FIG. 17 is an exemplary diagram of a chip set that can be used to implement an embodiment of the invention.

### DETAILED DESCRIPTION OF SOME EMBODIMENTS

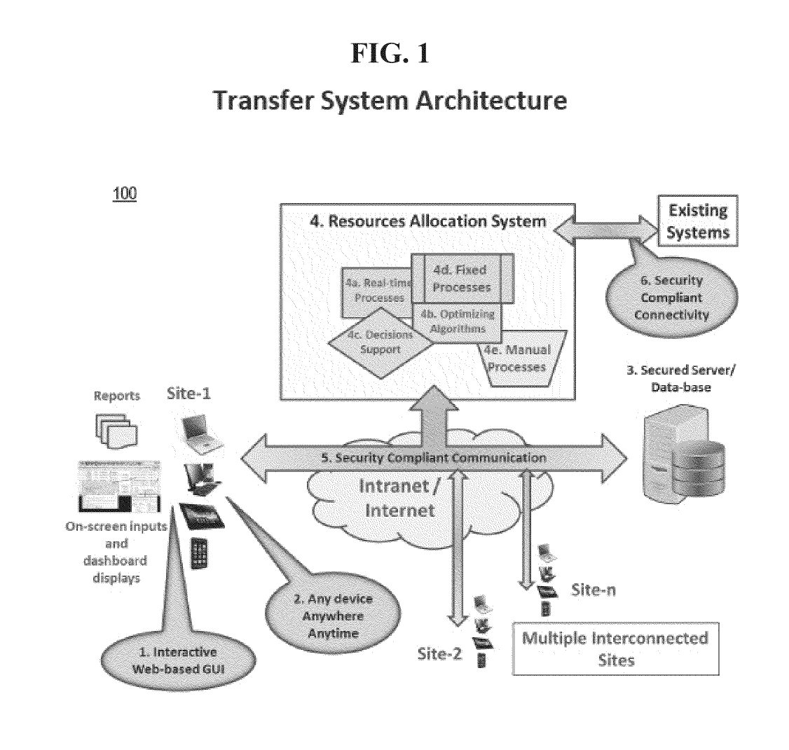

As shown in FIG. 1, the Transfer System 100 includes the functional components of the system that carry out the processes and methods of the system. It comprises:
1. An electronic device 2 with a customizable graphics user interface 1, such as, but not limited to, a hand-held mobile wireless smart phone, a wearable device, a tablet, or a personal computer, for access by users of the system to the functions and features of the system by securely connecting through a public or private communications network. A world-wide-web based architecture is used where the software based optimization platform and associated applications are accessed through a browser client residing in the said electronic device 2. The electronic device uses standards based operating system, such as, but not limited to, Windows, IOS, and Android, etc. The user interacts with the system through the browser on the electronic device displaying graphic information and images using various input mechanisms and sensory components. The browser is standards based, such as, but not limited to, Internet Explorer, Google Chrome, Safari, and Mozilla Fire Fox.

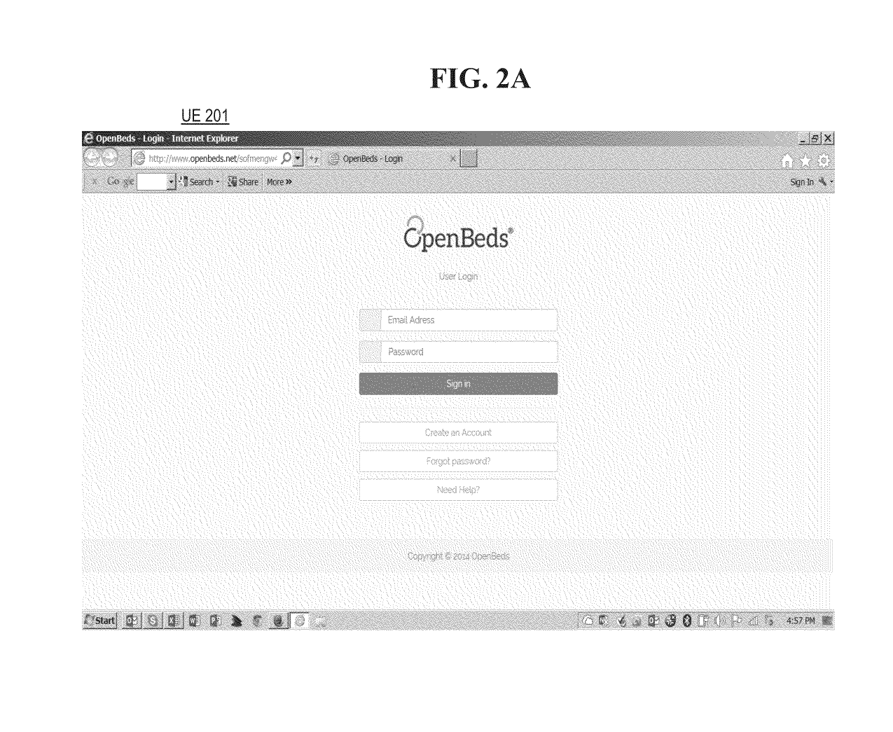

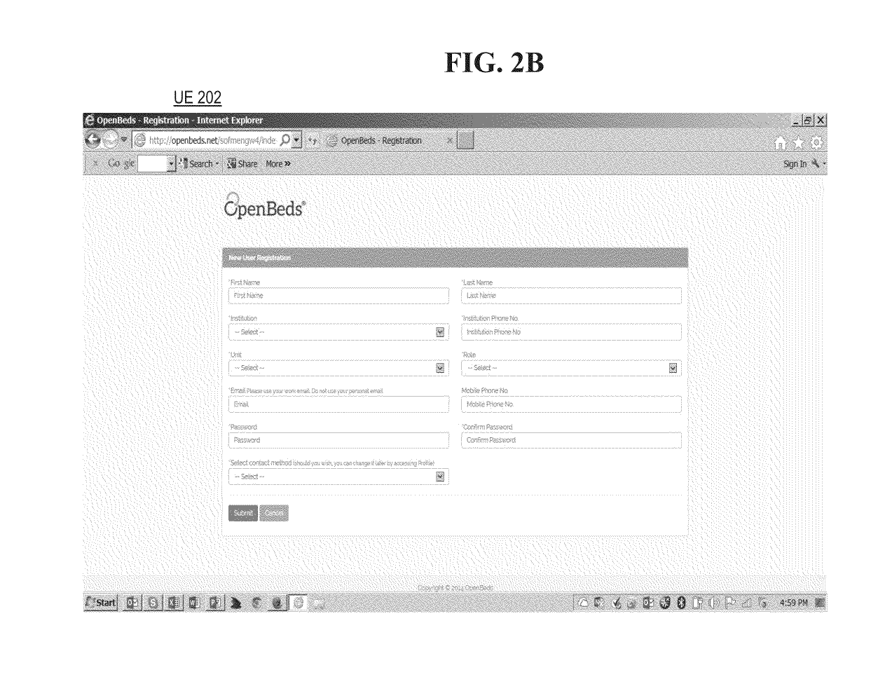

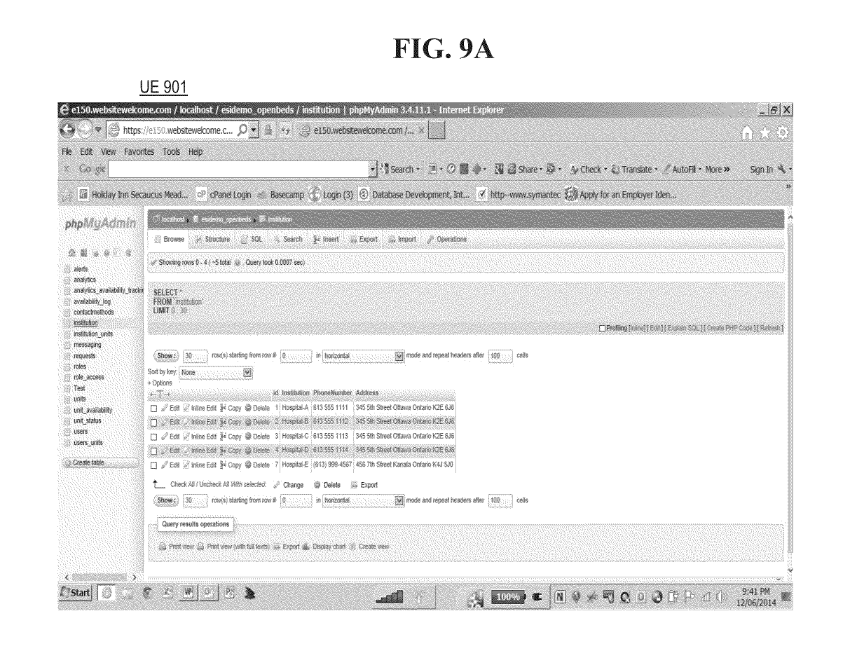

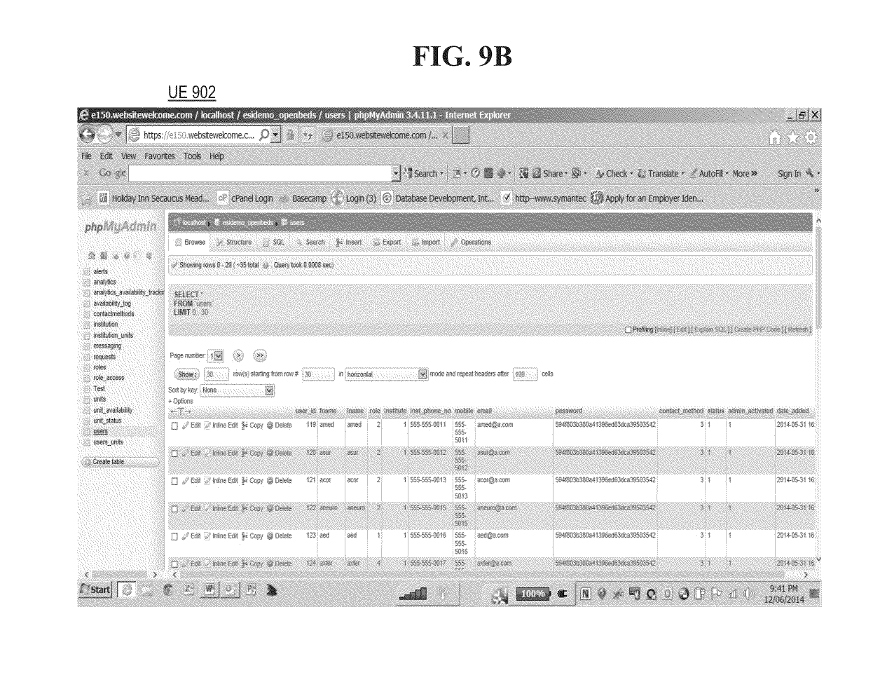

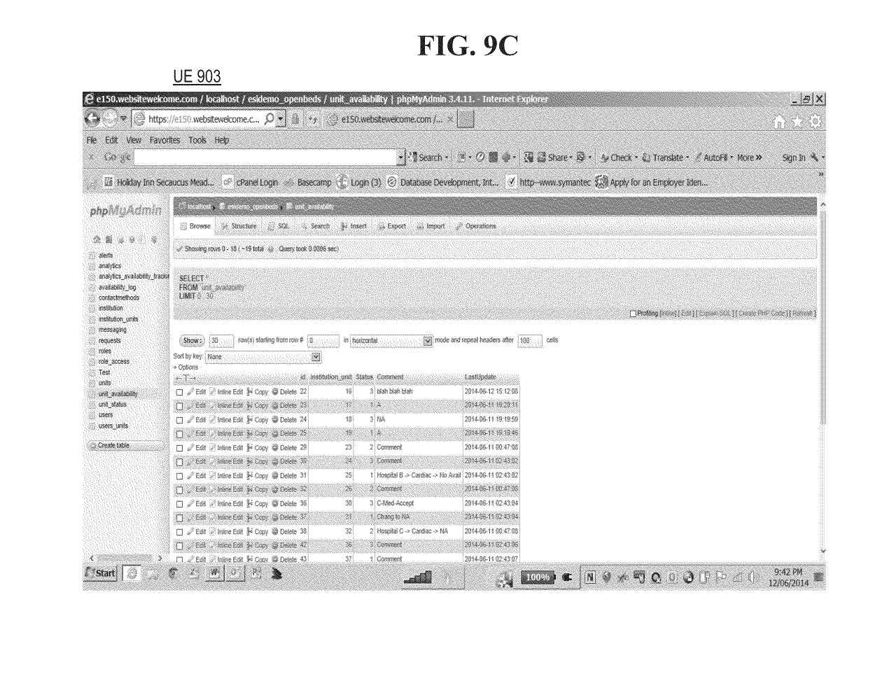

The strength and novelty of this innovation lies in the fact that the system 100 introduces the capability of providing an integrated set of unique graphic screens UE 101-UE 901, as shown in FIGS. 2-9 and 11, on the browser to the users of the system so that they can view the status of available facilities and make transfer requests with follow-up communications to make transfers of physical and tangible objects or people, happen in time conscious manner. This set of integrated interactive screens are configured to have visual displays of all data and information that is relevant for the transfer, and have configurable action buttons as well as ‘action taken’ and ‘send messages’ boxes along with ability to attach documents retrieved from other systems to facilitate communication between the sender and the receiver, and keep record of all such transactions. Additionally, in embodiments, the logged in user has an option of selecting other users of the system with their respective roles to whom a notification can be sent automatically by text on a mobile device or by e-mail of any action taken or message sent, asking the other selected user(s) to log into the system to check out if any action is required to be taken on their part. The graphical user interface screens are aligned with a novel stream-lined and efficient transfer process (to be described later in the following) and the roles of the users (generic roles to be described later in the following) involved in the transfer process—in that they are customized with visual display screens and process driven functionalities according to the role of the user of the system involved in the transfer process. The graphical user interface includes one or more user interface elements that are manipulated by the system's 100 hardware to provide valuable and real-time information.

As shown in FIG. 1, in embodiments, the system 100 includes one or more electronic devices 2, i.e., user equipment, at a first site (e.g., site 1) which may be utilized to execute one or more applications (e.g., sensors, web browser, media application, user interface, GPS, map application, web client, etc. but not limited to) to communicate with other electronic devices 2, one or more service providers, via a communication network 5. In one embodiment, the electronic devices 2 may include data collection modules for determining and/or collecting data associated with the electronic devices 2, one or more sensors of the electronic devices 2, one or more users of the electronic devices 2, applications, one or more content items, one or more values associated with the data, and the like. In one embodiment, the electronic devices 2 may include privacy/security modules for determining one or more privacy and/or security policies for the data and/or the one or more values. In one embodiment, the service providers may include and/or have access to one or more databases, which may include various user information, health care provider information, user profiles, user preferences, product information, service provider information, manufacturer information, other service provider information, and the like, but not limited to.

For security reasons, access control is based on a number of user-specific parameters, such as, but not limited to, affiliation with a legitimate Institution and Unit (transfer facility) of the Institution, legitimate e-mail address and password, input by the user through a registration screen. For confidentiality and data integrity reasons, communication with the system and with involved personnel through the system, across the public or private communication network 5 of system 100, are all encrypted using state of the art technology standards, but not limited to.

By way of example, the communication network 5 of system 100 includes one or more networks such as a data network, a wireless network, a telephony network, or any combination thereof.
2. A dual set of servers 3 are deployed which are configured to load-share and to provide reliability by making one available should the other fail. The servers 3 provide valuable services to the System 100.

A database management system resides in the server using state of the art technologies. A standards based backend interface is used between the user's client (browser) and the server to translate and display database contents on the user's browser described in the preceding. All information contained in the database is encrypted for security reasons using state of the art encryption technologies.

The servers, along with the database contained, are integrated into the system for access remotely by the user through the back-end interface and the public or private communication network. Algorithms deployed in the server and the database management system to collect and analyse data for optimized decision-making for transfers, provide visual display of data and information on the browser of the access device in real-time.
3. The Resource Allocation System 4 comprises support for Real-time Processes 4a, Optimizing Algorithms 4b, and Decision Support Analytics 4c. Additionally there are linkages to the existing Fixed Processes 4d and Manual Processes 4e to retrieve and/or input relevant data/information concerning facilities availability and patient health records, which then get massaged using predictive analytics algorithms to depict information, such as available (or not) facilities for transfer. All these processes entail successive steps required to support user-driven actions and outcomes which get incorporated in the said server's said database, and made available to the user on user's browser for the purpose of decision-making. The optimization algorithms deployed in the database management system manipulate real-time data for optimal decision making based on simple order ranking to the outcomes of analysis based on sophisticated linear and/or nonlinear mathematical programming/optimization techniques entailing user defined criteria and commensurate decision variables related inputs, such as, but not limited to, distance between geographic locations, travel time, costs, and policy variables.
4. The Resource Allocation System 4 may require access to electronic documents in the existing systems of the enterprise the Transfer System belongs to. To support retrieval and transmission of documents and Transfer System outputs into the existing systems, a secured connectivity 6 with compatible interface is provided using enterprise owned private communication network or intranet.

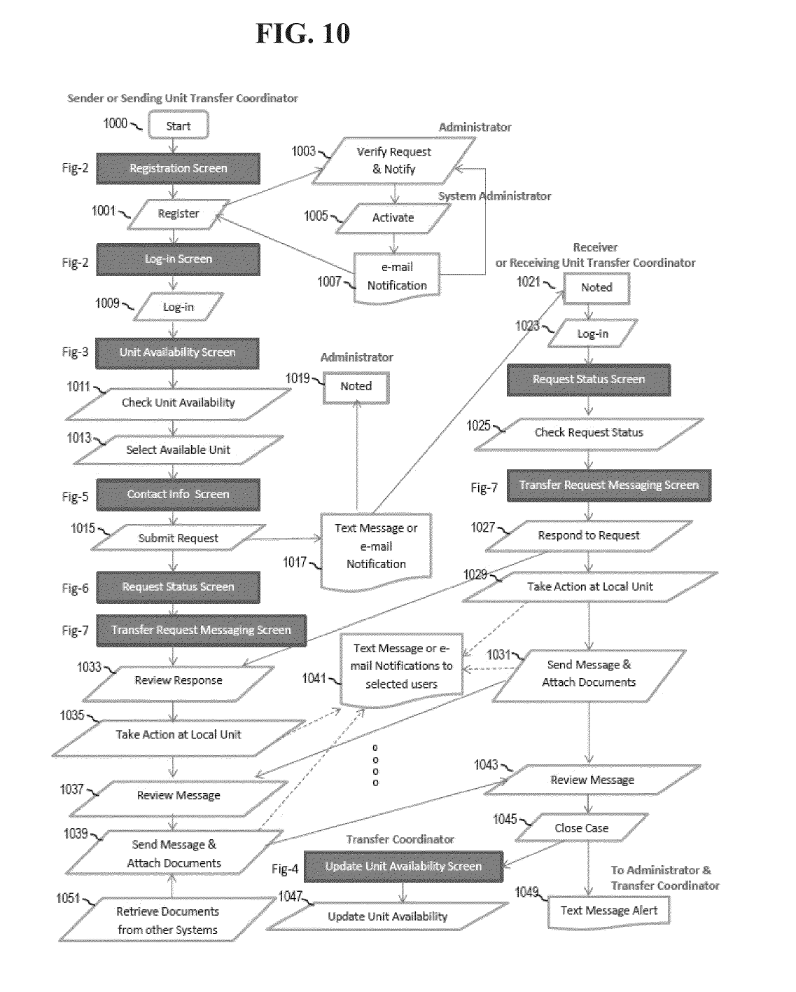

FIGS. 10, 12, and 13 depict stream-lined and efficient novel Processes which are embodiments of this Invention, comprising:
1. The processes in embodiment relating to tasks that must be carried out by the various personnel involved in carrying out the said transfer of tangible objects or people using this invention. Accordingly, these processes are aligned with the roles of the personnel involved in the transfer process.
2. The roles of the people involved in the transfer process are: Sending, Receiving, Transfer Coordination, and Administration belonging to the Units (facilities) of different Institutions located in different geographic locations. Additionally, the overall said Transfer System 100 is administered by a System Administrator. All these users with respective roles interact with each other through the Transfer System of this invention to facilitate transfers and manage the operations and the system.
3. FIG. 10 depicts the overall process of transferring objects and people from a Unit (facility) of an Institution to another Unit of same or another Institution. The process entails involvement of different users, and their interaction with each other through the Transfer System of this Invention. These processes are described in the following in the form of ‘use-cases’ involved in the transfer of patients in a Health Services Provider (HSP) enterprise described in the embodiments of this Invention, relating each use-case to the tasks required to be done and the processes involved in carrying out those tasks, which form embodiments of this Invention. The processes are explained using illustrative example of an HSP consisting of Intensive Care Units and Emergency Departments, without limiting the application of this Invention, since the tasks and processes to carry-out will be the same in any application of this Invention for the transfer of tangible physical object or people between different geographic locations; some of the examples are: locating available psychiatric service providers and transferring patients to; locating available nursing home facilities and transferring patients to; referral of patients to available specialized medical services providers. Regardless, the illustrative example used below forms preferred embodiments of this Invention for transfer of patients between different medical services provider facilities.

Transferring a Patient: A critically ill patient at a small community hospital needs diagnostics and/or therapeutics which are unavailable at the community hospital. The community physician caring for the patient wants to transfer the patient to a tertiary Institution's (hospital's) Unit (ICU). He would like to see the availability of intensive care units at multiple tertiary hospitals in the region, request a transfer and communicate with the tertiary unit physician. Most tertiary hospitals have multiple units (ICUs) which specialize in caring for different types of patients (e.g. Surgical ICU, Medical ICU, Cardiac ICU, Neurological ICU, Coronary ICU).

The Sender, a community physician (typically an emergency department or ICU physician) recognizes that the needs of the patient outstrip the resources available at the community hospital and decides to transfer the patient to a tertiary care hospital.

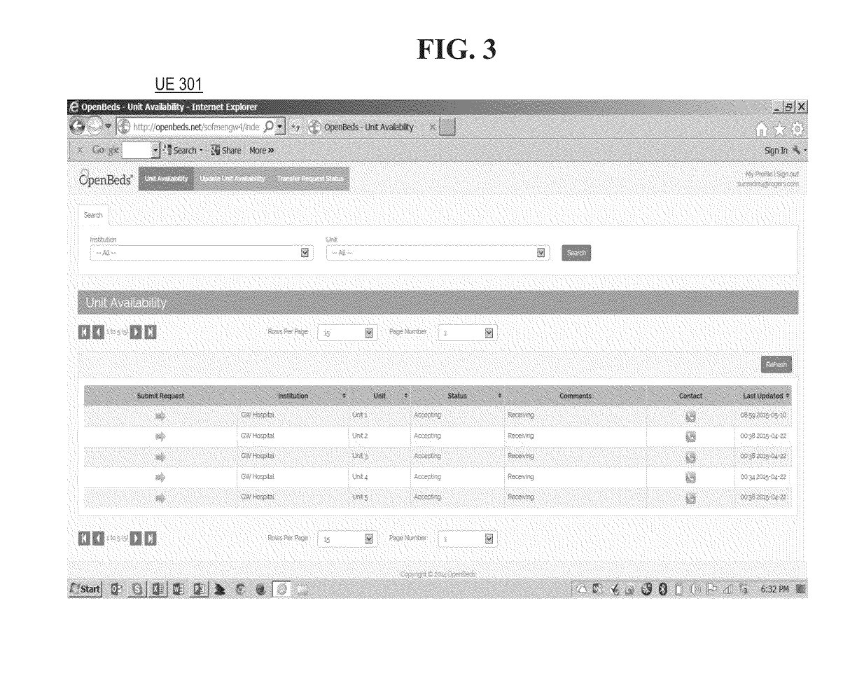

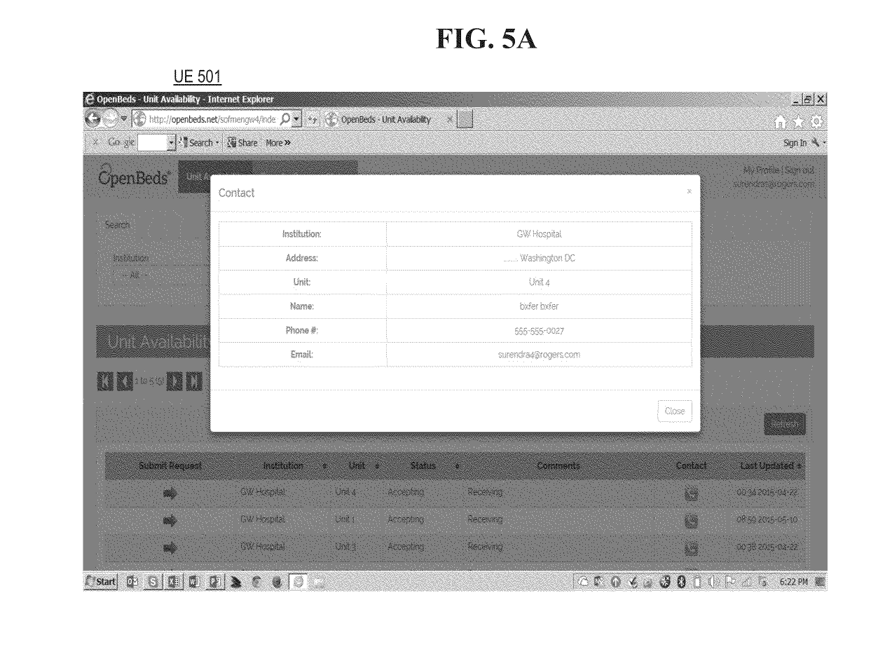

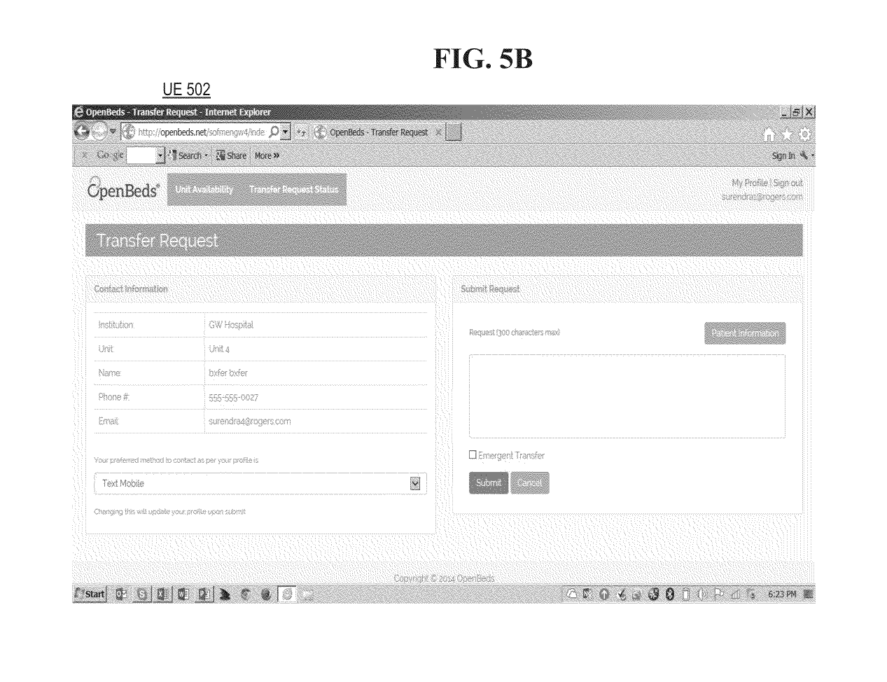

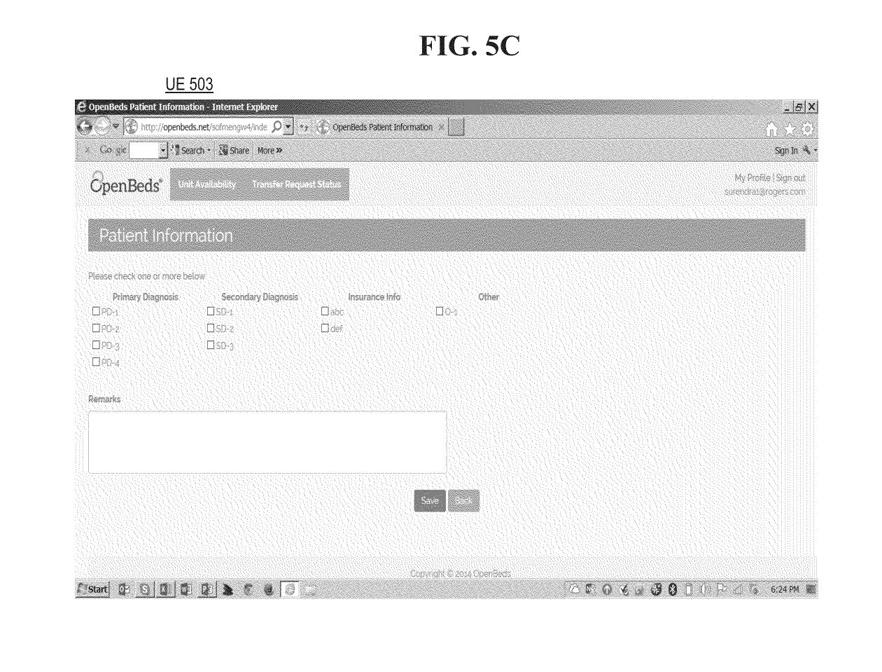

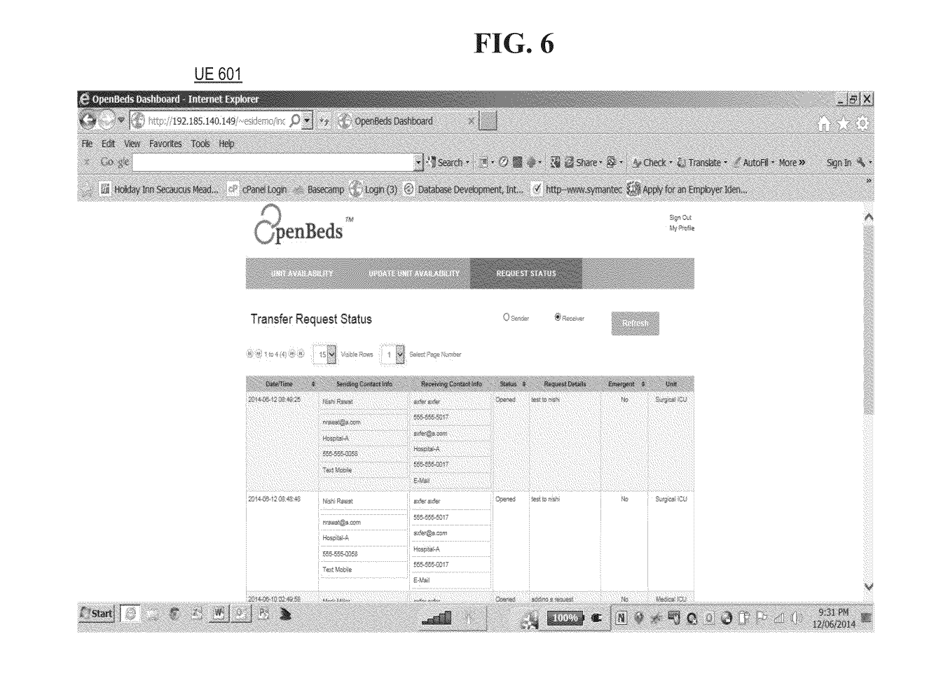

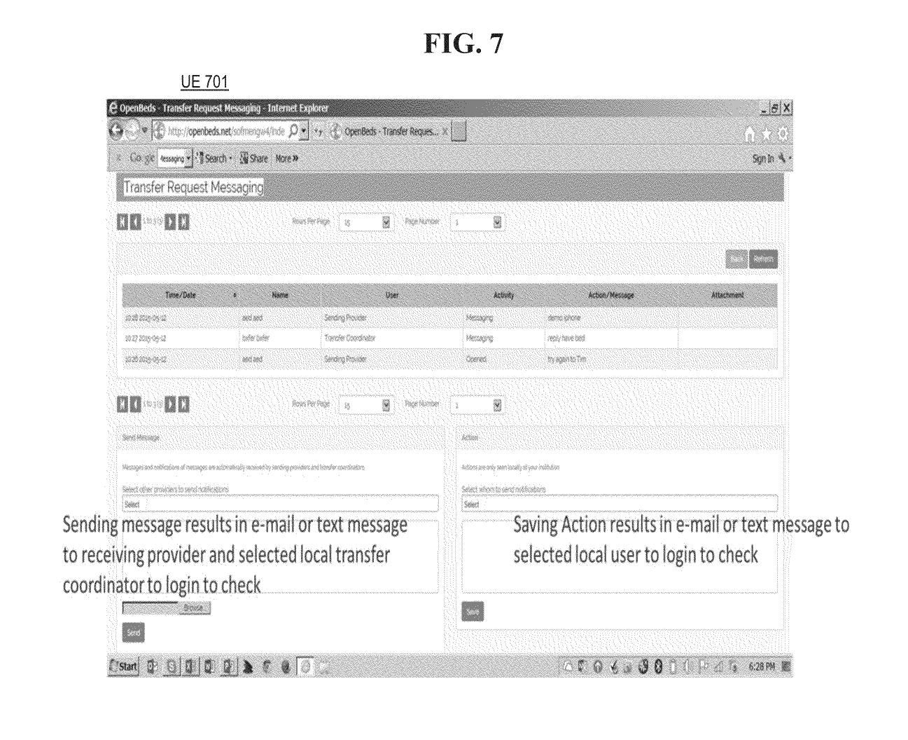

The sending process entails the steps identified clearly in FIG. 10. The registration process required before logging in requires the Sender to enter information about him in a form on the interactive screen (FIG. 2) consisting of certain mandatory and non-mandatory fields. The mandatory fields are used by the Administrator of the Institution the sender belongs to, to authenticate the sender, who in turn submits an activation request, electronically through the Transfer System, to the System Administrator to activate the sender's account, thus, subsequently providing password authenticated access to the system through a log in screen (FIG. 2). Through the registration process, the sender also identifies using what medium the sender would like to be contacted, such as, by text at mobile number, email, call at institution number, call at mobile number, or online through the Transfer System. Upon sign up the sender is taken to a ‘Unit Availability” screen (FIG. 3) depicting status of all Units (ICUs) of all Institutions (Hospitals) of the HSP, and the sender can select the Hospital and the ICU Unit from respective scroll down menus. The sender then looks up the required ICU bed availability at ‘Unit Availability’ page and gets contact information at ‘Contact’ page by clicking on the contact button of a specific selected unit (FIG. 3) to transfer patient. Through the Contact screen the sender can submit request for patient transfer to the selected unit (FIG. 5) by clicking on the submit button, which takes the sender to a Transfer Request page (FIG. 5b). Through this page the sender can submit request to the chosen unit's contact, typically, a Transfer Coordinator of that unit. The sender may include a brief description of patient condition, needs, and type of ICU bed requested in the text box and also by checking appropriate attributes on the pop-up page (FIG. 5c) accessible by clicking on Patient Information button on the Transfer Request Page (FIG. 5b). Patient identifiers may be submitted if site is HIPAA-compliant from patient's records confidentiality view-point. The sender can indicate as to whether request is emergent by checking ‘Emergent’ box. The sender can also change the method of getting contacted, which automatically changes the previously selected preference at the registration time in the sender's profile. The sender may wish to review status of transfer request and history of communication with receiving institution, which can be accessed through the Request Status tab on the top bar of the screen (FIG. 6). The sender may then view his request which is summarized in table with Date and Time, Sending Contact, Receiving Contact, Request Details and Emergent notation. Any subsequent actions taken at the site of the sender in connection with the transfer request made can be documented on a separate screen entitled Transfer Request Follow-ups (FIG. 7), accessible from the Request Status page by clicking on the information related to that transfer. The information related to the action taken is local in nature, hence it is not visible to the receiver of the transfer request. The sender can have further dialogue with the receiver through this Transfer Request Follow-up page (FIG. 7) by sending electronic messages, in text, picture, or voice form, and also by attaching any relevant documents, including but not limited to, patient information and patient health records. Sent messages are visible to the receiver as well. The user may choose to select from a drop down menu users to whom a notification is sent via a text message or e-mail to log into the system and look at the action taken. Likewise automatic notifications of any messages are sent to the senders and receiver via text or e-mail, including notifications to other users selected from the drop down menu, for them to log into the system and read the sent messages. History of all actions taken and messages exchanged is recorded on this follow-up page. Upon completion of patient transfer, the receiver can close the case by clicking on the radio button on this page, a notification of which is also sent to the sender. The case can be reopened by clicking on the open button subsequently by the sender or the receiver, should that be required for some reason.

The sender can log out of the system by clicking on the ‘Sign Out’ tab at top of any page.

Responding to electronic transfer request and completing the transfer: The “receiving process” entails the steps identified clearly in FIG. 10. ‘The receiver’ at the receiving end of the request for transfer from the sender's site to the receiver's site, in this example, which is in embodiment of this invention, will typically have a Transfer Coordinator for the receiving Institution (a tertiary hospital) or for the requested Unit of that tertiary hospital. Upon registration and logging into the system using the procedure described in the preceding for any user of the transfer system, the transfer coordinator is brought directly to ‘Transfer Request Status’ page (FIG. 6), where the transfer coordinator may then review all requests which are summarized in table with Date and Time, Sending Contact, Receiving Contact, Request Details and Emergent notation. He can click on a specific transfer request to view a summary of the transfer details and communication on the Transfer Request Follow-up page (FIG. 7). The transfer coordinator may take an action and record it on this page, the action being local to that Unit, is not visible to the sender on the same page. He can also respond to the request by sending a message to the sender via text box on this page; additionally, he can attach to his message any document retrieved electronically from other systems of the Unit. The user (sender or receiver) can also select from a drop down list of users as to who else should be notified of any action taken and saved, or any message sent by him. The notification is sent by a text message or e-mail to the selected users so that they can log into the system upon receiving the notification, to take any action should they need to take in accordance with their respective roles. Through back and forth electronic communications between the sender and the receiver, patient transfer is accomplished. The Transfer Coordinator may also view ‘Unit Availability’ page, and ‘Contact’ for each Unit.

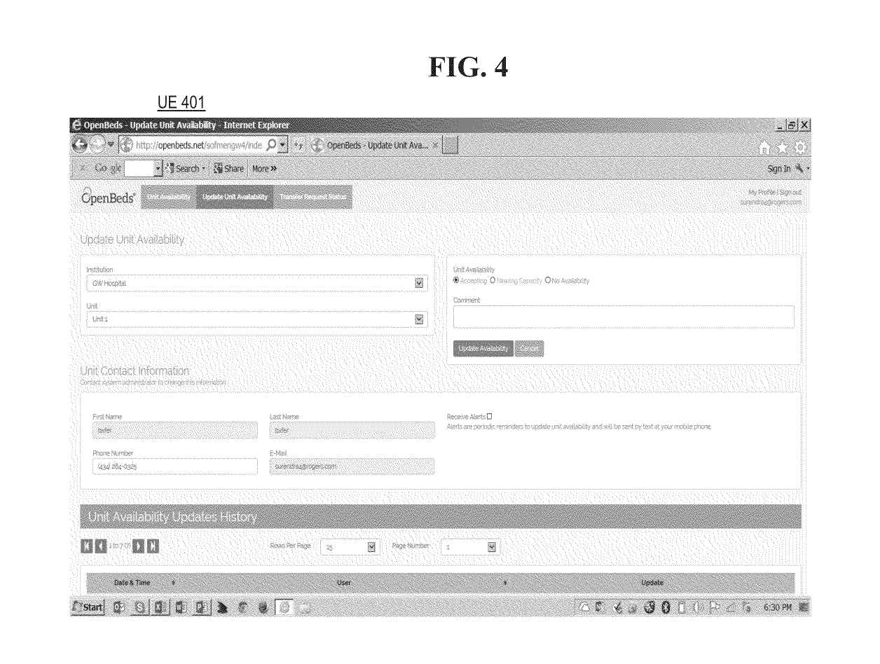

The Transfer Coordinator has write privileges for ‘Update Unit Availability’ page (FIG. 4), if chosen so by the receiving Institution.

Transfer coordinator can sign out of the Transfer System using ‘Sign Out’ tab at top of any page.

Updating Unit (facility) Availability Status: Someone, with up-to-date knowledge regarding the Unit availability at the tertiary hospital needs to update the Unit availability, for example, every 4 to 6 hours, or on an as needed basis. The person, the ‘updater’, updating the availability information can be a physician, nurse, bed coordinator, or a transfer coordinator. The designated person may opt by checking a box on the Update Unit Availability page (FIG. 4) to receive a reminder alert via text message to do this every 4 to 6 hours. The registration and login procedure for this person is the same as for any other user of the system, as described in the preceding for a sender. Upon logging in the updater is taken to the ‘Update Unit Availability’ page (FIG. 4). At top of this page, name of Institution and the Unit is listed. If provider has privileges to update status of only one Unit, then only this is displayed. If provider has privileges to update status of multiple Units, then he can select different Units using drop down menu. The updater selects the Unit to update, and selects red, yellow or green status (meaning Not Available, Nearing Capacity, and Available respectively), and in addition, the updater fills in the ‘Comment’ box before saving to update. Contact Information is pre-filled (entered by the System Administrator)—this field may be manipulated by the System Administrator such that it is read-only or writeable by the tertiary provider, depending on customer's requirement. The ‘Receive alert’ checkbox is set to default at none/empty; if this is checked, then the updater is prompted to a) enter mobile number and mobile service providing carrier's name, b) enter alert time interval, and (c) when to stop sending alerts. Updater then saves changes by pressing ‘Update Availability’ button. Updater can see log of updates to availability at bottom of the page. As the information is saved by the system 100, the data is manipulated and modified in system storage (e.g., memory) that is accessible across the network. Further, the updater can view Unit availability across all Units, and ensure that his Unit update is visible, by clicking on the ‘Unit Availability’ tab at top of the page. He may also see ‘Contact’ information for any given Unit via the buttons at this page (FIG. 3). Where existing systems of the HSP have facilities availability information, or data from which such information can be derived using predictive analytics in the System, such information is automatically updated in the system periodically. As such, the system 100 provides numerous technical advantages and benefits not appreciated in conventional systems and definitely not in the prevailing manual systems with limited communication and analytic capabilities.

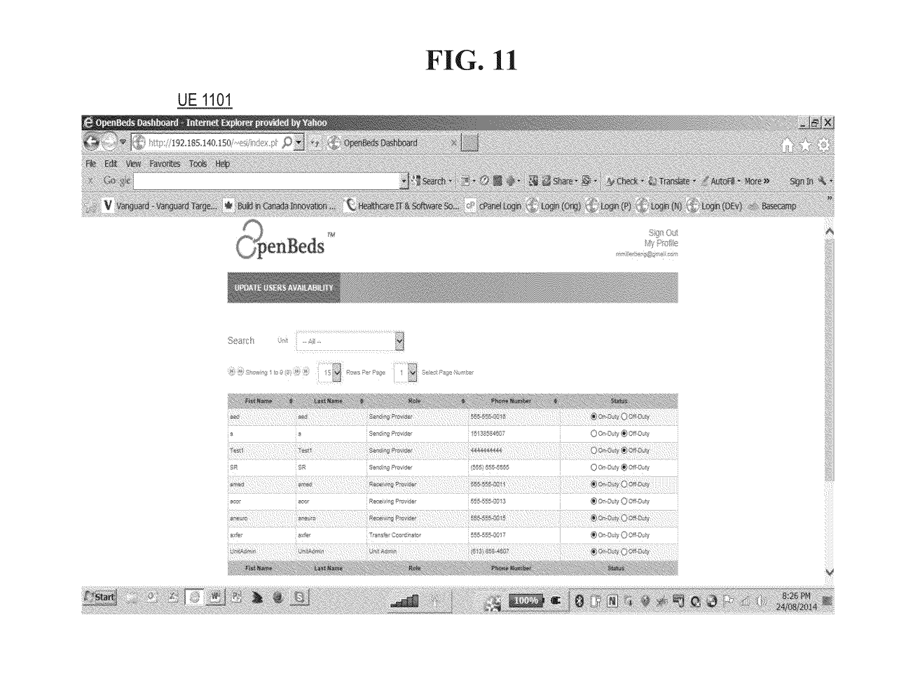

Unit (Facility) Administration: A Unit Administrator at the receiving Unit of the receiving Institution would like to ensure that the system maintains and displays at any point in time the list of various registered users of the Unit, whether or not they are available or unavailable, i.e., on-duty or off-duty, so that only those available in their respective roles are communicated through the system to carryout transfers related transactions and communication at that point in time. Upon registering and logging in using procedures described in the preceding, the Unit Administrator is immediately taken to ‘Update Users Availability’ page (FIG. 11) to view and update Unit's users' availability. Updates are done by using applicable ‘on-duty’ or ‘off-duty’ radio buttons on the graphic display screen.

The Site Administrator signs out of the Transfer System using ‘Sign Out’ tab at top of the page.

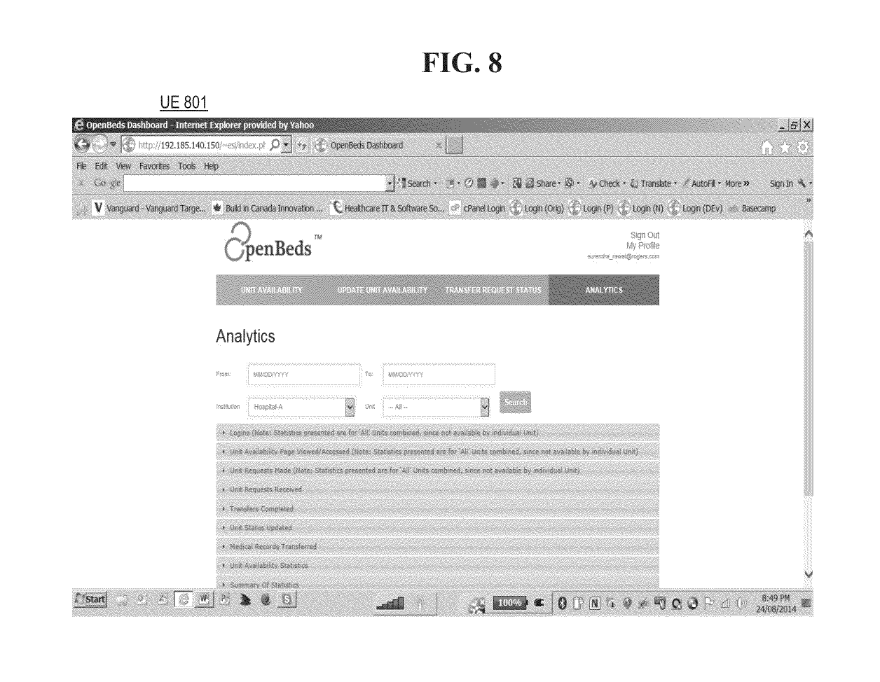

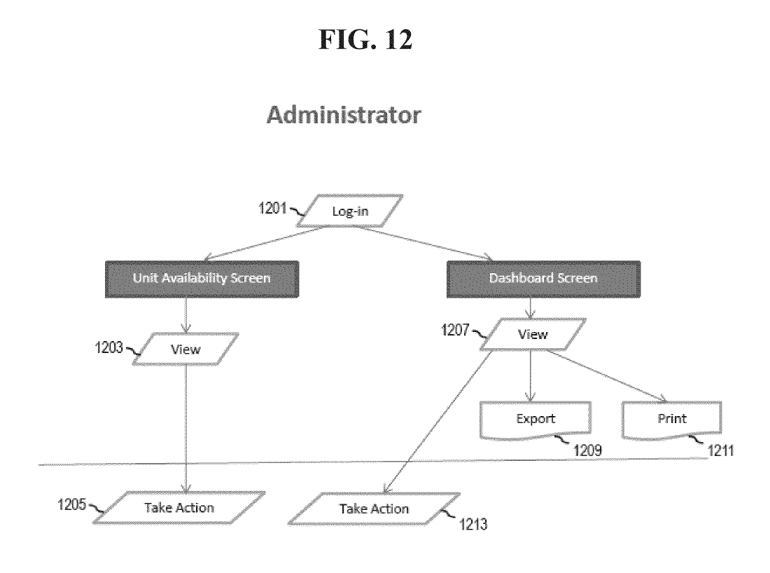

Site Administration: An Administrator at the receiving Institution (tertiary hospital) would like to see Units availability at his Institution, along with metrics regarding demand and use, and Transfer System's website use for the purpose of optimal allocation of resources and maximizing capacity (FIG. 12, steps 1201-1213). Upon registering and logging in using procedures described in the preceding, the Administrator is immediately taken to ‘Unit Availability’ page (FIG. 3) to view Units availability across his Institution only. He may also view contact information for any given Unit. Any new user registration request goes to the Administrator electronically, which he verifies and electronically submits to the System Administrator to activate the requesting users account and permit logging into the system (FIG. 10). The Administrator may tab to “Analytics” page (FIG. 8) to view metrics for his Institution and one or more, or all of the Units collectively, by filtering using a drop down menu on the Analytics page (FIG. 8). Statistics comprise, but not limited to, page views by sending physicians over a time interval, unit availability by Unit (percentage of time spent red, yellow or green) for a given time interval, snapshot of when (calendar view) Units were on red, yellow or green for a given time interval, number of times status updated per Unit for a given time interval, number of transfer requests by senders (physicians) using the Transfer System, and other relevant metrics.

The Administrator signs out of the Transfer System using ‘Sign Out’ tab at top of any page.

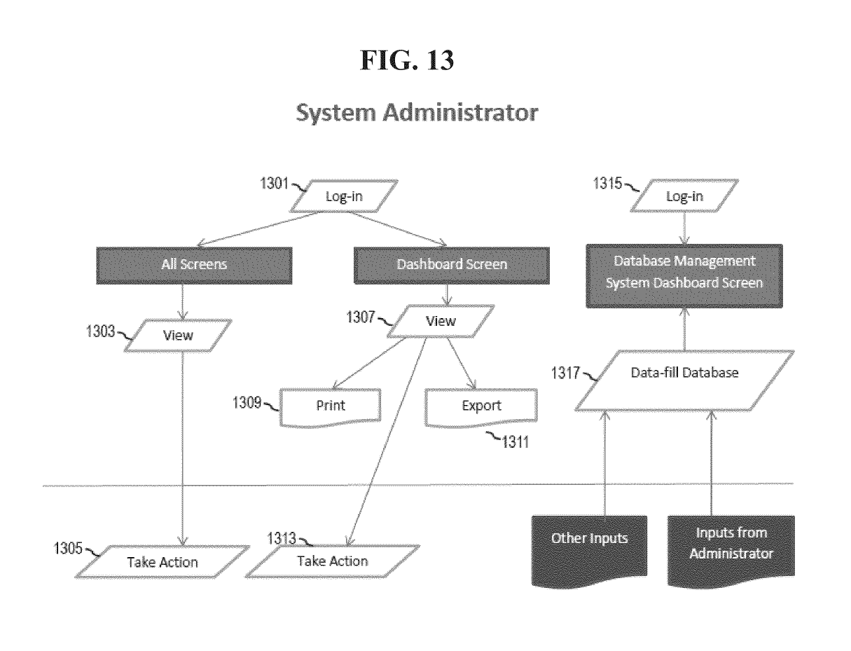

System Administration: Overall administration of the Transfer System is done by a “System Administrator.” All activities related to maintaining the components of the Transfer System (FIG. 1) are responsibility of the Administrator (FIG. 13, steps 1301-1317). Upon user request for account activation to login via the Administrator of the Institution the requester belongs to, the System Administrator activates the requesting user's account, thus permitting him logging into the system. The database contents for a Transfer System, in this case the Health Services Provider (HSP)'s Transfer System, include all information about: the Institutions (hospitals) including their addresses and contact phone numbers; Units (Facilities) belonging to each Institution, including Contact information for each Unit; user identification, including name, e-mail address, phone number, role, read/write privileges with corresponding accessibility to one or more of the system's screens to enable undertaking role-specific tasks. Most of such data is provided to the System Administrator by the Administrator of the Institutions belonging to the HSP system for the System Administrator to data-fill the database on the server using a graphics user interface and/or by importing externally prepared soft files into the database. Some of the tasks of data-filling the database may be delineated to Administrators of Institutions belonging to the HSP system by providing them with electronic access to parts of the database using a graphics user interface. Any breakdowns during the use of the system, or any help related queries from the users, are directed to the System Administrator via the Transfer System to resolve.

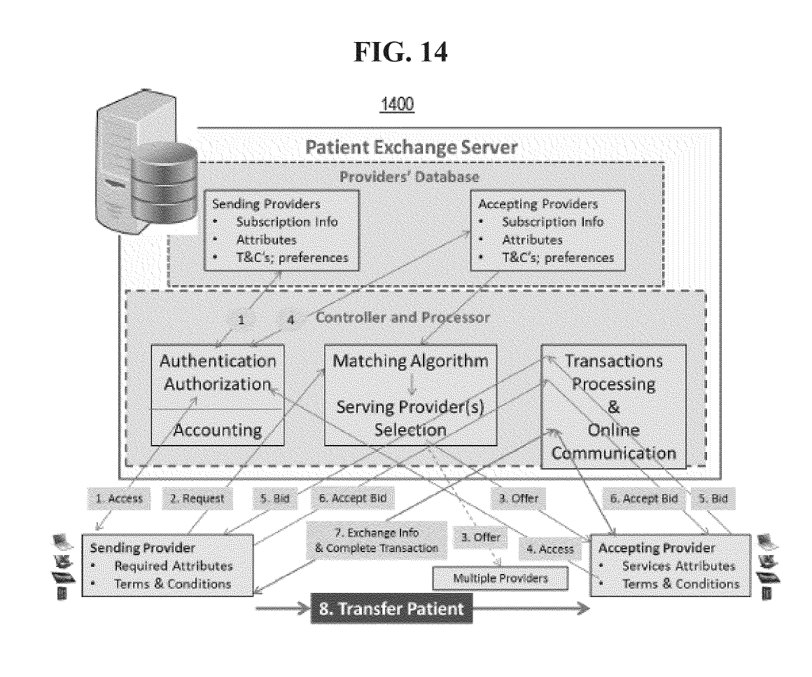

While the processes which are embodiments of this invention have been disclosed using patient transfers in a Health Services Provider system of Institutions (Hospitals) and their facilities (Units) as an example, the processes are equally and in totality applicable to transfer of any tangible physical objects or people. The said processes as such make up embodiments of the present invention. The screens depicted for the above exemplary patient transfer system may change without changes in spirit and scope of this embodiment. An additional manifestation of the system is depicted in FIG. 14 whereby a sending HSP can use the system as a repository of patients to be transferred, and any other HSP may choose online to have communication with the sending HSP to transfer the patient to its own facility. All processes for such transfers are extensions of the process depicted in FIG. 10, steps 1000-1051, including various screens depicted in FIG. 2-9, but not limited to in spirit and scope.

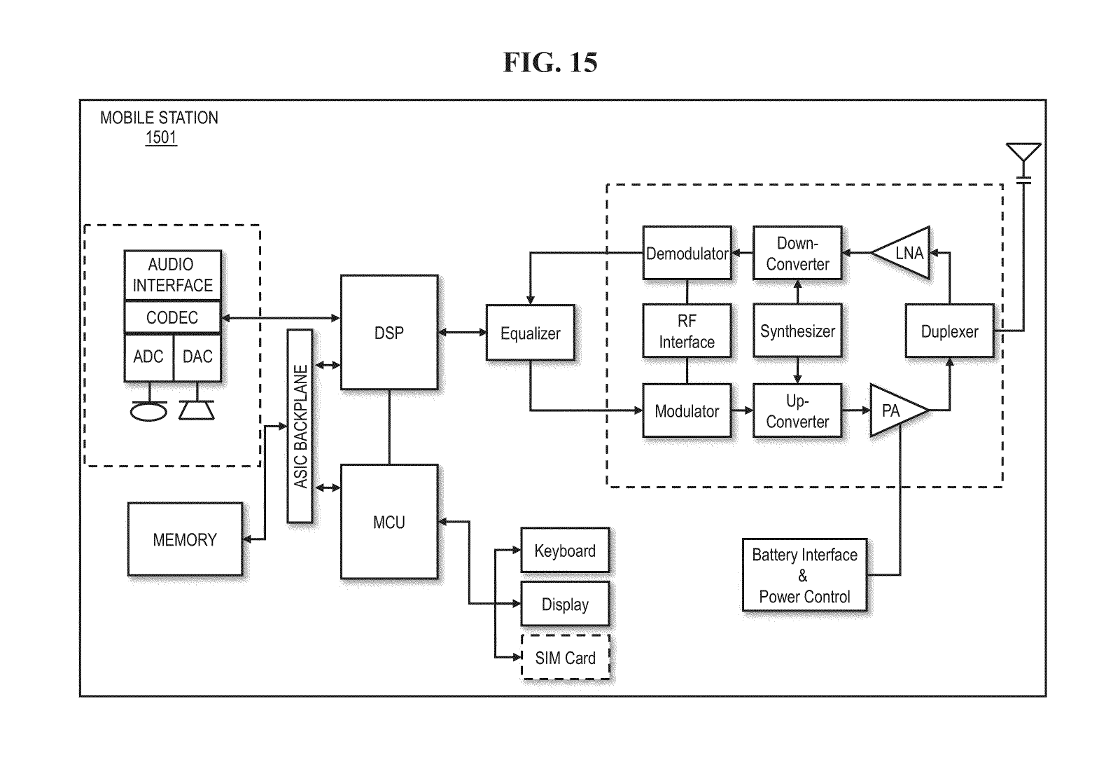

FIG. 15 is a diagram of exemplary components of a mobile terminal 1501 (e.g., handset) for communications, which is capable of operating in the system of FIG. 1, according to one embodiment.

The processes described herein for processing one or more user inputs that include one attributes and criteria with the user interface element to a cause a determining of optimized available units for transferring patients, objects, and/or electronic data, and causing a presenting of the availability and other information in real-time via a configurable user interface based, at least in part, on the one or more attributes and criteria, may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

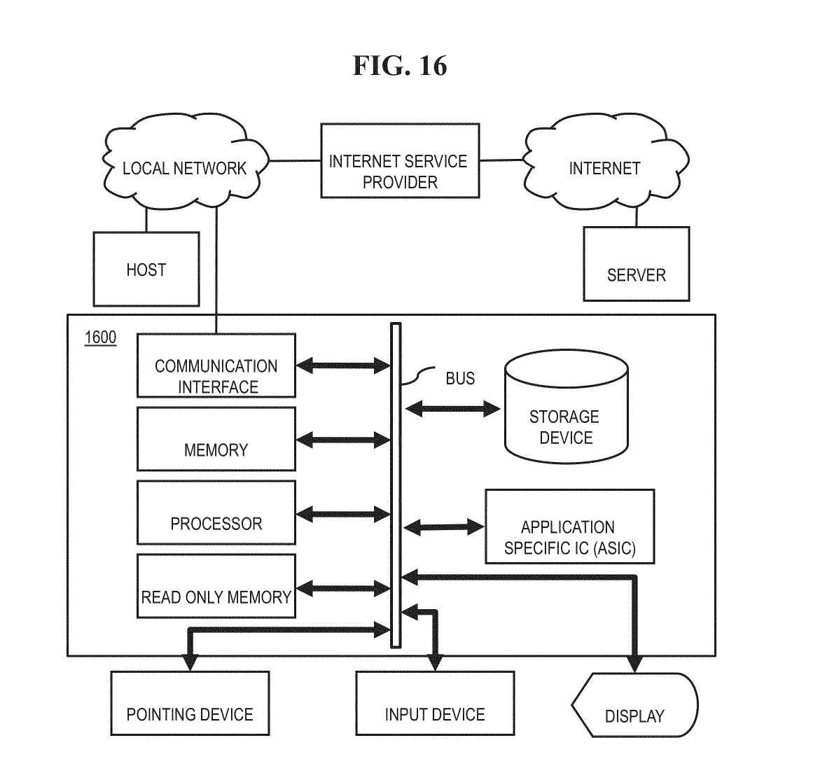

FIG. 16 illustrates a computer system 1600 upon which an embodiment of the invention may be implemented. Although computer system 1600 is depicted with respect to a particular device or equipment, such as mobile device 2, it is contemplated that other devices or equipment (e.g., network elements, servers, etc.) within FIG. 16 can deploy the illustrated hardware and components of system 1600. Computer system 1600 is programmed (e.g., via computer program code or instructions) to process one or more user inputs that include one attributes and criteria with the user interface element to a cause a determining of optimized available units for transferring patients, objects, and/or electronic data, and causing a presenting of the availability and other information in real-time via a configurable user interface based, at least in part, on the one or more attributes and criteria.

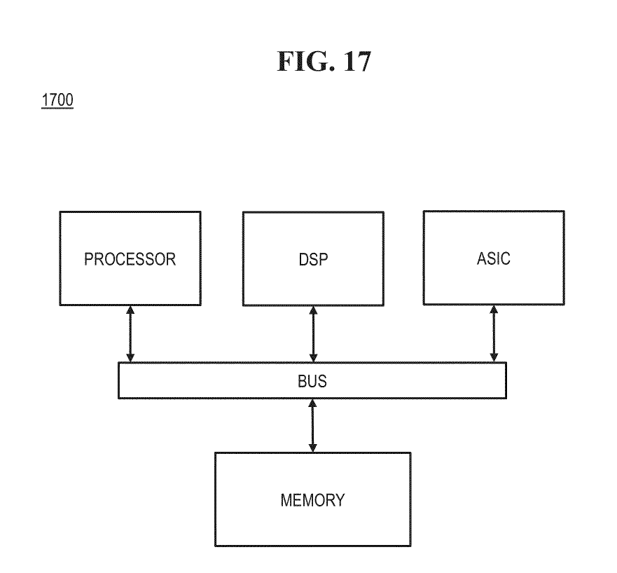

FIG. 17 illustrates a chip set or chip 1700 upon which an embodiment of the invention may be implemented. Chip set 1700 is programmed to process one or more user inputs that include one attributes and criteria with the user interface element to a cause a determining of optimized available units for transferring patients, objects, and/or electronic data, and causing a presenting of the availability and other information in real-time via a configurable user interface based, at least in part, on the one or more attributes and criteria, as described herein and includes, for instance, the processor and memory components described with respect to FIG. 17 incorporated in one or more physical components of the system of invention included herein.

While the invention has been disclosed in connection with preferred embodiments of OpenBeds®, a patient transfer system, shown and described in detail above, various modifications and improvements thereon will become readily apparent to those skilled in the art. Accordingly, the spirit and scope of the present invention is not to be limited by the foregoing example, but is to be understood in the broadest sense allowable by law.

1. A system to manage transfer of tangible physical objects or people between different geographic locations, the system comprising:
at least one electronic device including a customizable graphics user interface, such as, but not limited to, a hand held mobile wireless smart phone, a wearable device, a tablet, or a personal computer or electronic work station, for providing one or more users of the system access to the functions and features of the system via a secure public or private communications network;
at least one electronic computer-centric server including a database management system, the at least one electronic computer-centric server being integrated into the system for access remotely from the said electronic device through an appropriate back-end interface;
at least one processor and one or more processing algorithms embedded in the server and the database management system, the at least one processor and one or more processing algorithms are configured to collect, analyse, and cause a presentation of a visual display of and transfer of data and information on the electronic access device in real-time;
a plurality of customizable and interactive graphic display screens configured to be presented on the said electronic device and configured to allow the a user to interact with the system for the purpose of said transfers of objects or people, and retrieving data and information in real-time; and
an electronic interface configured to permit the system to interface via a private or public communications network with one or more other systems for retrieving or transmitting relevant data and/or information to support said transfers of objects or people.

2. The system of claim 1, a world wide web based architecture where the software based application of the system is accessed through a browser; the electronic device uses a standards based operating system, such as, but not limited to, Windows, IOS and Android, and a browser, such as, but not limited to, Internet Explorer, Google, Chrome, Safari, Mozilla Fire Fox, configured for causing a display of the graphic information and images.

3. The system of claim 1, wherein the user is permitted access to the system via a public communication network or a private telecommunications network using technologies, such as, but not limited to, HTTPS and SSL encryption for secured communication.

4. The system of claim 1, wherein to ascertain security of data and information, contents of the database in the said database management system is encrypted using SHA1, but not limited to this only.

5. The system of claim 1, wherein the said server is deployed along with another paired server operating-for load balancing and as hot standby in case of failure of one or the other server to provide a high degree of reliability.

6. The system of claim 1, wherein one or more optimization algorithms deployed in the database management system manipulate real-time data for optimal decision making based on simple order ranking methods to the outcomes of an analysis based on sophisticated linear or nonlinear mathematical programming/optimization techniques entailing user defined criteria and commensurate decision variables or attributes related inputs, such as, but not limited to. Distance between geographic locations, travel time, costs, and policy variables, for optimal resource allocations, commensurate with requested transfers of objects or people.

7. The system of claim 1, wherein one or more predictive analytics algorithms are configured to be applied to relevant data of a service provider collected from existing systems of the service provider linked to the system through customizable graphical user interfaces for calculation and an autofill of the availability of one or more facilities, and wherein the predictive algorithms include a range of techniques from simple statistical regression techniques to more advanced predictive algorithms.

8. The system of claim 1, wherein a plurality of inter-related and integrated screens for display and interaction with the user in real-time on the said electronic device are custom designed for a specific application to facilitate interaction with the system.

9. The system of claim 1, wherein the custom designed interactive screens, commensurate with an application, on the said electronic device, allow the user to communicate securely with other systems in the context of the system's operations to support the said transfer of objects or people.

10. The system of claim 1, wherein custom designed processes utilize the said System for transfer of one or more patients between facilities of Health Services Provider (HSP) network; the system further comprising:
a Patient Transfer System including Units as facilities supporting differing health services that belong to respective Institutions at different geographic locations, which are all part of the HSP network; and
one or more processes facilitating said patients transfer; such processes may entail (a) directed transfers, whereby the sending HSP selects the receiving HSP and communicates with the receiving HSP for patient transfer, and (b) the sending HSP offers the patient to be transferred by storing patient information in the system of claim 1 for any potential HSP to receive the patient upon successful communication with the sending HSP through the system.

11. A method comprising:
providing one or more users of a system access to the functions and features of the system via a secure public or private communications network, the system being configured to manage transfer of tangible physical objects or people between different geographic locations;
providing a remote electronic device to access an electronic computer-centric service quipped with a database management system integrated into the system through a back-end interface;
receiving one or more user inputs via one or more graphic display screens configured to be provided by the electronic device;
retrieving and causing at least in part, a presentation of data and information in real time via the one or more graphic display screens;
processing one or more algorithms embedded in the electronic computer-centric server and database management system of the electronic computer-centric server, the one or more processing algorithms are configured to collect, analyse, and cause a presentation of a visual display of data and information on the electronic access device in real-time;
retrieving and transmitting relevant data and/or information via an electronic interface via a private or public communications network to support said transfers of object or people;
collecting, analyzing, storing in the database and displaying on the device screen, system operations and performance related analytics relating to all interactions of users with the system with capability to filter information based on the user defined criteria; and
ability to print or electronically export in digital form any collected data or screen displays.

12. The method of claim 11, further comprising delineating user-roles with commensurate access to one or more functions and features of the system based on the use of the system consistent with the role of the user involved in the said patient transfer process, the users are Institution's medical staff, such as, nurses and doctors, support personnel, and hospital administrators;

13. The method of claim 12, wherein the user-roles relate to Sending patients, Receiving patients, Transfer Coordination, internal Institute Administration, and the said Patient Transfer System Administration;

14. The method of claim 11, further comprising allowing the one or more users access to one or more of the interactive graphic display screens on the electronic device in accordance with their respective said user-roles.

15. The method of claim 11, further comprising determining user access to the system based on multiple identifying parameters input by the one or more users for authentication and authorization using an interactive graphic user interface screen, and with involvement of an Institution's Administrator and the System Administrator;

16. The method of claim 11, further comprising causing at least in part, a display of a status of at least one Unit on an interactive graphics display screen on the electronic device, wherein the at least one Unit is displayed in at least one of three states: Green, i.e., Available, Red, i.e., Not Available, and Yellow, i.e., Nearing Capacity.

17. The method of claim 16, further comprising selecting from the d display an appropriate Unit (facility, such as an ICU Unit) of an Institution (such as a Hospital) within the HSP network; and contacting the Receiver or Transfer Coordinator of that Unit by electronic communication for the purpose of a patient transfer.

18. The method of claim 11, further comprising recording in the database, in real-time with a time stamp, actions taken within a Unit in response to a transfer request through an interactive graphics display screen.

19. The method of claim 11, further comprising processing real-time back and forth communications between Receiving and Sending Units users, notifications of actions and sent messages by text message or e-mail to selected users, including electronic transfer of electronic health records, in support of transfer of patients and commensurate actions required.

20. The method of claims 18 and 19, a process to display and keep record of actions taken and communications done with time-stamp in the database for the purpose of audits and analytics for system performance evaluations.

21. The method of claim 16, updating in real time the availability of a Unit at an Institution using a graphic interactive screen; the graphic interactive screen being configured to permit selection of the Unit in any of the said three states, Green, Red and Yellow.

22. The method of claim 21, displaying on graphics screen and keeping historic record of real-time updates of a unit's availability in the database for the purpose of audits and analytics for system capacity assessments.

23. The method of claim 21, sending periodic alerts by text or eMail messages to remind the user to update unit's availability, including when to stop sending alerts.

24. The method of claim 11, using an interactive screen updating the presence or absence of an HSP Unit's personnel so that system can accordingly facilitate sending text or eMail notifications to present personnel with a specific role when an action is taken by someone and such personnel must be notified to take action in response.
